(19) United States
(12) Patent Application Publication
(10) Pub. No.: US 2006/0023717 A1
(43) Pub. Date: Feb. 2, 2006

(54) Wireless transmission with variable code rate

(75) Inventors: Eyal Trachtman, London (GB); Carole Plessy-Gourdon, London (GB); Paul Febvre, London (GB); Panagiotis Fines, London (GB)

Correspondence Address: STERNE, KESSLER, GOLDSTEIN & FOX PLLC, 1100 NEW YORK AVENUE, N.W., WASHINGTON, DC, 20005, US

(73) Assignee: Inmarsat Ltd., London (GB)

(21) Appl. No.: 10/501,736

(22) PCT Filed: Jan. 20, 2003
(86) PCT No.: PCT/GB03/00238

§ 371 Date: Jul. 16, 2005

(51) Int. Cl. H04L 12/56

(52) U.S. Cl. 370/392; 370/474

(57) ABSTRACT

A wireless communication system uses an adaptive air interface in which burst parameters are variable on a burst-by-burst basis, based on the reception quality of previous bursts and/or properties of the receiver or receivers of the burst. The parameter values are selected as sets which represent only some of the possible combinations of parameter values, to avoid redundancy in performance characteristics. Coding rates are selected to give a substantially constant increment in gain. Each burst may contain multiple FEC blocks with different coding rates. A unique word indicates the FEC coding rate of the first block and the first block identifies the coding rate of each of the subsequent blocks.

### FIELD OF THE INVENTION

The present invention relates to a communication method, apparatus, system and signal, particularly but not exclusively for adapting parameters of a wireless interface to terminal type and/or link conditions.

### BACKGROUND OF THE INVENTION

Adaptive power control techniques are known for adapting a wireless interface to link conditions. Furthermore, EP-A-0 772 317 describes a technique in which both power and forward error correction (FEC) coding are varied according to fading conditions at a receiver, which are reported to the transmitter using a low-bandwidth return link.

Also known are wireless communications systems which support different types of terminal with different characteristics. For example, the Inmarsat™ geostationary satellite system supports a number of different services, including Inmarsat-M™, Inmarsat mini-M™ and Inmarsat-M4™, each designed for different types of terminal. However, each service uses a separate, pre-defined set of channels each having a predefined channel type.

It would be advantageous to provide a flexible wireless interface that can be adapted to link conditions and/or terminal type.

It would also be advantageous to allow channels for different terminal types to be multiplexed onto the same bearer.

It would also be advantageous to allow channels multiplexed onto the same bearer to be adapted to link conditions independently of each other.

It would also be advantageous to provide a high degree of freedom in the adaptation of parameters of a wireless interface.

The document EP-A-0 878 924 discloses a TDMA communication system which allows mobile terminals to be set for working in any one of a number of different communication environments, such as a pedestrian environment, a vehicular environment, a satellite environment and an office environment. The transmission format has a fixed frame length and number of bits per slot, but has different sets of values for power, modulation method, number of multiplexed signals, error correction, antenna gain, frequency hopping and diversity for each environment. A mobile station and base station select one of these sets for communication with each other. The selection may be made manually by the mobile station user, automatically by the mobile station detecting broadcast messages from the base station indicating which environments are available, or automatically by estimation of the transmission channel.

The document EP-A-1 130 837 discloses a packet data burst format including a unique word, a header modulated with a default modulation and coding scheme and a payload modulated with a modulation and coding scheme specified by the header.

The document EP-A-0 680 168 discloses a method of “slicing” in the time and frequency domains to provide efficient allocation to users with different requirements.

The document EP-A-0 651 531 discloses a communication technique using a variable error correction bandwidth.

### STATEMENT OF THE INVENTION

According to one aspect of the present invention, there is provided a satellite communication method wherein a satellite terminal varies the coding rate of bursts transmitted to a satellite base station under the control of a satellite base station, so as to maintain the quality of reception of bursts at the satellite base station at a predetermined level. The coding rate may be varied between different predetermined values which give substantially constant gain increments.

According to another aspect of the present invention, there is provided a method of wireless transmission of a burst containing packets addressed to different ones of a plurality of receivers, comprising determining the receiving capabilities of the receivers and selecting at least some of the transmission parameters of the burst to match the capabilities of the least capable of the receivers.

According to another aspect of the present invention, there is provided a method of transmitting a burst including a unique word and a plurality of FEC coding blocks, wherein the unique word indicates the FEC coding rate of the first block and the first block identifies the coding rate of at least a subsequent one of the blocks, which coding rate differs from that of the first block. This technique allows the coding rate to be varied within a burst so as to match the capabilities of different receivers, and identifies the different coding rates to the receivers.

According to another aspect of the present invention, there is provided a channel assignment scheme in a wireless communication system which allows bursts on a channel to contain multiple packets addressed to different receivers, wherein receiving terminals having similar receiving capabilities are grouped onto the same forward channel, so that optimum transmission characteristics can be selected for each burst.

The scope of the present invention extends to apparatus, systems, signals, data structures and programs for carrying out any of the above methods.

### BRIEF DESCRIPTION OF THE DRAWINGS

Specific embodiments of the present invention will now be described with reference to the accompanying drawings, in which:

FIG. 1 is a schematic diagram of a satellite communications system in an embodiment of the present invention;

FIG. 2a is a schematic diagram of a transmitter channel unit in the embodiment;

FIG. 2b is a schematic diagram of a receiver channel unit in the embodiment;

FIG. 3 is a diagram of an FEC encoder used in transmitter channel unit;

FIG. 4 is a diagram of an SRCC coding module in the FEC encoder;

FIG. 5 is a frequency/time diagram illustrating forward bearers sharing frequency channels;

FIG. 6 is a frequency/time diagram illustrating return bearers sharing frequency channels;

FIG. 7 is a diagram of one specific type of forward bearer format;

FIG. 8 is a diagram of one specific type of return bearer format; and

FIG. 9 is a diagram of an example of a forward bearer carrying multiple terminal connection packets with a varying coding rate.

### DETAILED DESCRIPTION OF EMBODIMENTS OF THE INVENTION

Mobile Satellite System

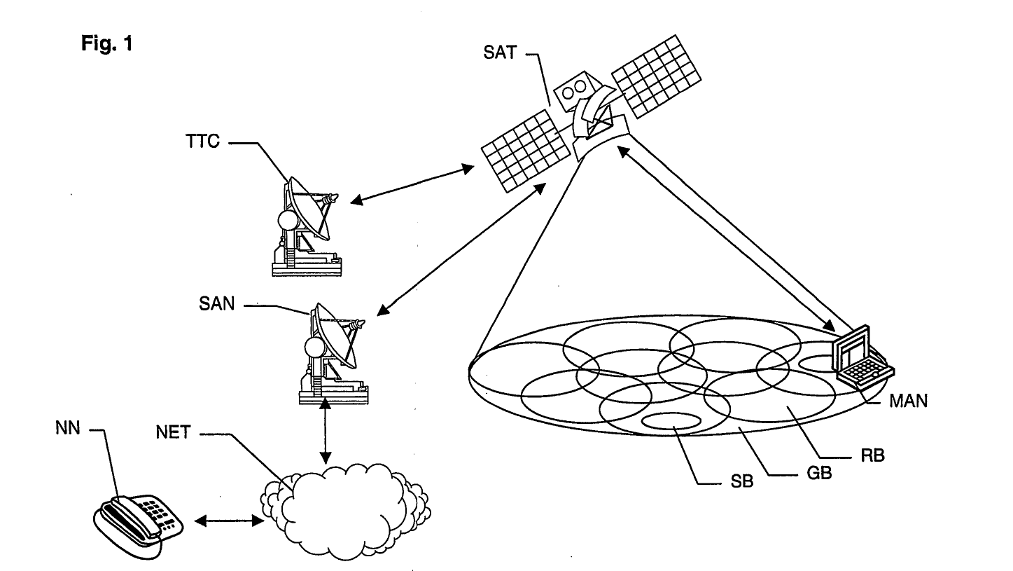

FIG. 1 shows schematically a geostationary satellite communication system including one or more satellite access nodes (SANs) which act as gateways to other communications networks NET for communication with any of a large number of network nodes NN. Each SAN is able to communicate with a plurality of mobile access nodes (MANs) using radio frequency (RF) channels retransmitted by a geostationary satellite SAT. RF channel bandwidths of 90 kHz and 190 kHz are supported by the transponder design of the satellite. The feeder link transmitted and received between the SAN and the satellite comprises a set of frequency channels at C band, while the user link transmitted between the MANs and the satellite comprises a set of frequency channels at L band. A transmission in the direction from the SAN to one or more of the MANs is referred to as a forward link, while a transmission in the direction from one of the MANs to the SAN is referred to as a return link. Channel conditions on the feeder link may vary depending on atmospheric conditions and sources of interference. Channel conditions on the user link may also vary depending on atmospheric conditions and sources of interference, which may depend on the position of the relevant MAN. Hence, user link conditions may vary between MANs.

Satellite

The satellite SAT includes a beam former, receive antenna and transmit antenna (not shown) which generate substantially congruent receive and transmit beam patterns. Each beam pattern consists of a global beam GB, a small number of overlapping regional beams RB which are narrower than and fall substantially within the global beam, and a large number of spot beams SB (only two of which are shown, for clarity) which are narrower than the regional beams and may fall either within or outside the regional beams, but fall substantially within the global beam. Each spot beam may or may not overlap another spot beam, and at least some of the spot beams are steerable so that their area of coverage on the earth's surface can be changed.

The satellite includes a transponder which maps each C-band frequency channel received in the feeder link onto a corresponding L-band frequency channel transmitted in a specified beam in the user link, and maps each L-band frequency channel received in each beam in the user link onto a corresponding frequency channel in the feeder link. The mapping between frequency channels can be altered under the control of a telemetry, tracking and control (TTC) station. The satellite SAT acts as a ‘bent pipe’ and does not demodulate or modify the format of the signals within each frequency channel.

One example of parameters of a spot beam is given below.

TABLE 1
Satellite Spot beam Parameters

| Satellite Parameter | Forward | Return |
|---|---|---|
| NPR | 17 | 20 |
| Co-channel level (50%) | 19 | 19 |
| L-Band G/T (dB/K) | −10 | 10 |
| Transponder gain | 180 | 182 |
| EIRP (dBW) per carrier | 44 | — |

Terminal Types

The satellite communication system is designed to provide simultaneous services to a very large number of MANs of different types. For example, a handheld (HH) terminal has very low RF power, an antenna which is substantially omnidirectional in azimuth, and typical dimensions of 10 cm×5 cm×1 cm. A pocket-sized or A5 terminal has low RF power, a directional antenna ANT with small aperture and typical dimensions of 20 cm×15 cm×2 cm. A notebook-sized or A4 terminal has medium RF power, a directional antenna of medium aperture and typical dimensions of 30 cm×20 cm×3 cm. A briefcase-sized or A3 terminal has high RF power, a directional antenna of large aperture and typical dimensions of 40 cm×30 cm×5 cm.

In one example, the parameters of the terminal types are as shown in Tables 1 and 2 below:

TABLE 2
Terminal Parameters

| Terminal Parameter | HH | A5 | A4 | A3 |
|---|---|---|---|---|
| Target L-band fade margin | 4.5 | 3.7 | 3.1 | 2.5 |
| G/T | −23 | −18 | −12 | −9 |
| RF Power (W) | 1.5 | 1.9 | 2.8 | 7.2 |
| Antenna gain | 3.5 | 7.5 | 12 | 15.2 |
| Pointing loss | 0.4 | 0.8 | 1.2 | 1.5 |
| Max EIRP towards satellite | 4.6 | 8.6 | 13.6 | 20.9 |

The terminal type of the MAN may be identified to the SAN during registration of the MAN with the SAN, or the SAN may obtain this information from an external source based on the identity of the MAN.

Transmitter Channel Unit Details

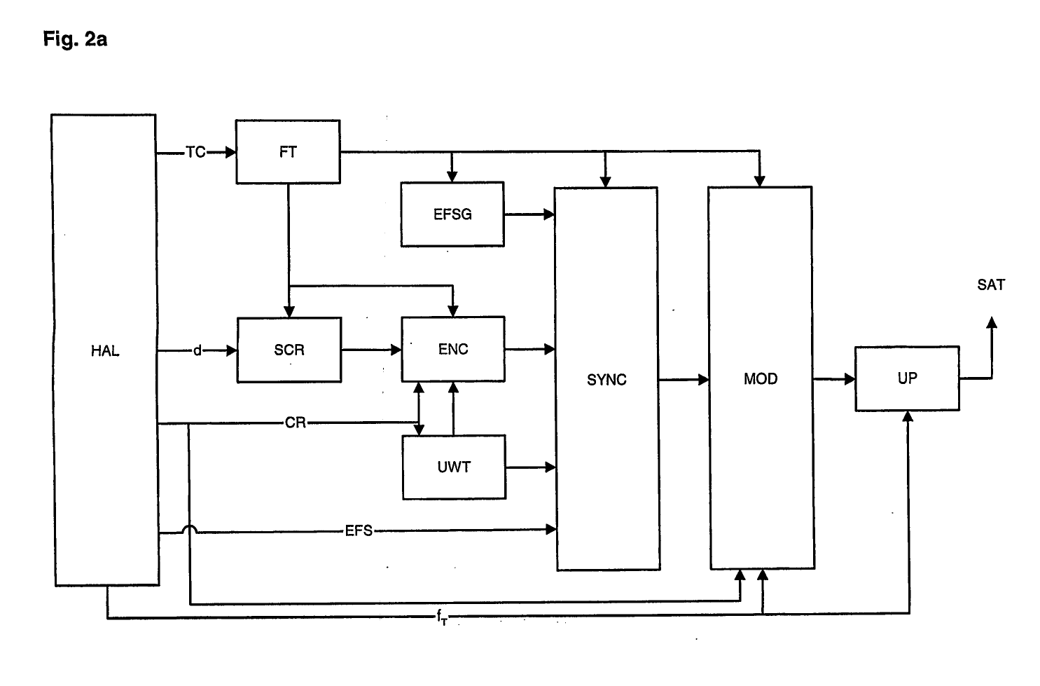

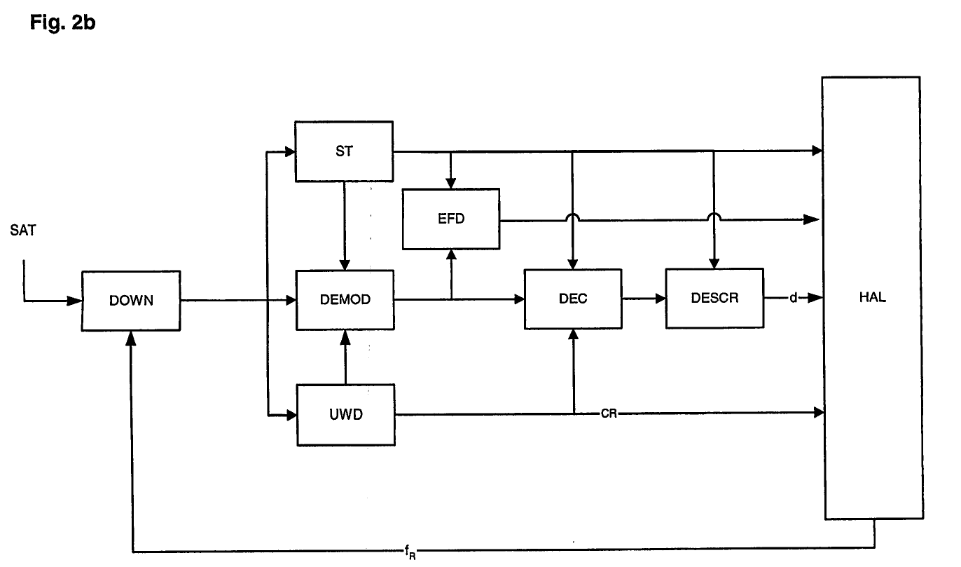

FIG. 2a shows the functions of a transmitter channel unit (TCU), which performs the encoding and modulation of signals for transmission over a single frequency channel. The SAN contains multiple such TCUs, sufficient for the maximum number of transmitted frequency channels in the feeder link. Each MAN contains at least one TCU.

A hardware adaptation layer HAL provides an interface between the channel units and higher-level software which controls the settings of the channel units, handles the demodulated received signals and outputs the signals for transmission. The higher-level software may include a medium access control (MAC) layer which maps logical channels onto bearer connections and bearer connections onto the physical layer, as described for example in EP-A-0 993 149.

In the TCU, the HAL outputs data blocks of a predetermined but variable block size, containing data bits d, which are scrambled by a scrambler SCR and redundancy encoded by an encoder ENC at a coding rate CR set by the HAL.

Data and parity bits are output from the encoder ENC to a transmit synchroniser SYNC which formats the bits into modulation sets, each of which determines the modulation state of one modulated symbol, for output to a modulator MOD which modulates the sets according to a variable modulation scheme output by the HAL. Unique word (UW) symbols are also input from a unique word table UWT to the synchroniser SYNC for output in accordance with a selected air interface format as will be described below. Empty frames, which are used as input if no data is to be sent, in response to empty frame signalling EFS from the HAL, are generated by an empty frame signalling generator EFSG.

The output timing of the different stages is controlled by a frame timing function FT which receives timing corrections TC from the HAL. The HAL selects the output frequency of the transmitter channel unit TCU by controlling a transmit frequency f_{T} of an upconverter UP, the output of which is transmitted to the satellite SAT.

Receiver Channel Unit Details

FIG. 2b shows a receiver channel unit (RCU), which performs the demodulation and decoding of signals received on a single frequency channel. The SAN contains multiple such RCUs, sufficient for the maximum number of received frequency channels in the feeder link. Each MAN contains at least one RCU.

In the RCU, a frequency channel is received from the satellite SAT, down-converted by mixing with a downconversion frequency signal at a downconverter DOWN at a reception frequency f_{R} controlled by the HAL, and demodulated by a demodulator DEMOD.

The frame timing of the bursts is determined by a receive synchronisation timing detector ST and by a unique word detector UWD. The demodulated burst is decoded by a decoder DEC according to a coding rate CR determined by the unique word detector, and descrambled by a descrambler DESCR. The data contents of the burst are then received by the HAL. Empty frames are detected by an empty frame detector EFD.

The receive timing may be determined by a decoder-assisted frame synchronisation technique, as described for example in GB-A-2371952, or in the paper ‘Decoder-assisted frame synchronisation for Turbo coded systems’, Howlader, Wu and Woerner, 2^{nd} International Symposium on Turbo Codes, Brest, September 2000.

FEC Coder Details

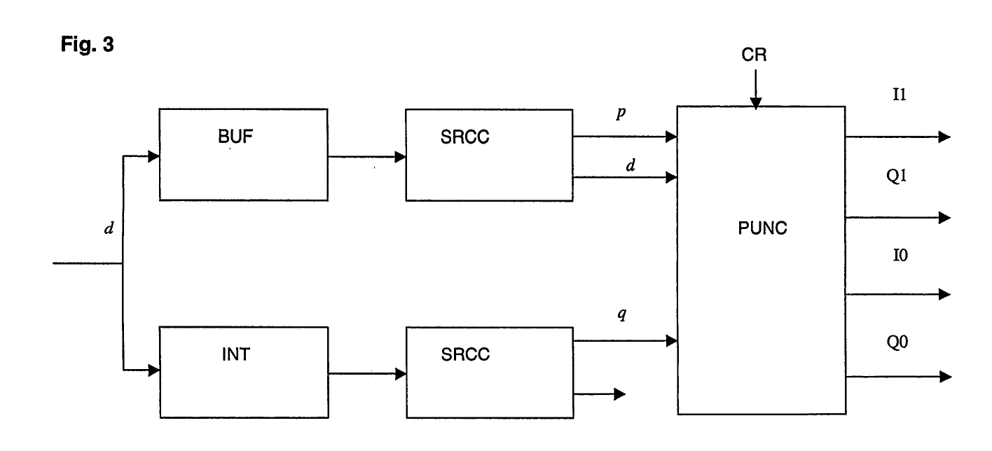

In a preferred embodiment, the encoder ENC performs a Turbo encoding algorithm such as described generally in the paper ‘Near Shannon limit error-correcting coding and decoding: Turbo codes’, Berrou, C., Glavieux, A. and Thitimajshima, P, Proc. of ICC '93, pp 1064-1070 or with enhancements such as described in WO99/34521. A Turbo coder, as shown in FIG. 3, consists of a buffer BUF and an interleaver INT which both receive data bits d in parallel and output the data bits to respective identical 16-state Systematic Recursive Convolutional Code encoders SRCC with respective streams of parity bits p, q. The unencoded data bits d, and the parity bits p, q are output to a puncturer PUNC which generates modulation sets of bits from all of the data bits d and some of the parity bits p, q according to a puncturing matrix which determines which of the parity bits p, q are selected for transmission, and hence the coding rate. The puncturing matrix can be modified to change the coding rate CR, as dictated by the HAL.

The size of the interleaver INT determines the encoder block size; a block of data bits d is loaded into the buffer BUF and the interleaver INT, the block of data bits d is encoded by the SRCC encoders and the punctured bits are output by the puncturer PUNC.

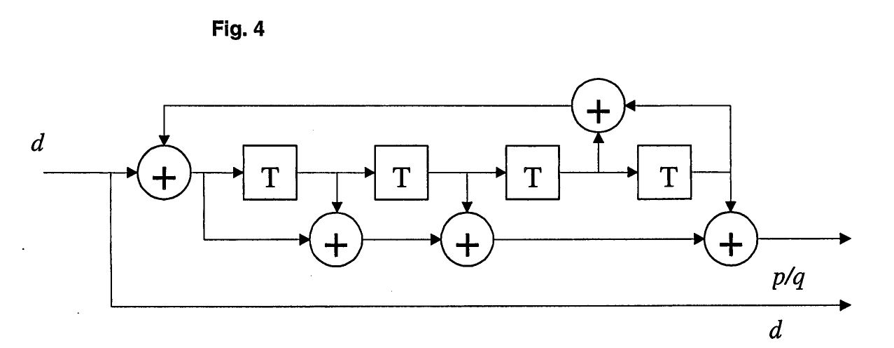

FIG. 4 shows the structure of either of the SRCC encoders. Input data bits d are supplied in parallel to a systematic data output and to a recursive convolutional encoder comprising four shift registers T and binary adders, arranged as shown in FIG. 4 to output the parity bits p or q. The backward polynomial is 23₈ and the forward polynomial is 35_{g}:

Backward polynomial: 1+X³+X⁴

Forward polynomial: 1+X+X²+X⁴

The SRCC encoders are initialised by setting the shift registers T to a zero state before each block of data bits d so that their output does not depend on the bits from any previous block. No flush bits are added.

Any suitable algorithm, such as the well-known MAP or SOVA algorithms, may be used in the decoder DEC.

Bearer Types

It is not possible to provide a single air interface standard which optimises the transmission rate available to the larger terminals while maintaining communication with the smallest terminals. This problem is solved by supporting a plurality of different bearer types defined by their symbol rate and modulation scheme.

Each bearer is defined as a burst within a frame or slot in a Time Division Multiplex (TDM)/Time Division Multiple Access (TDMA)/Frequency Division Multiple Access (FDMA) scheme; in other words, bearers are separated by frequency (FDMA), each frequency channel is divided into periodic frames, each frame either containing one bearer or being divided into two or more timeslots each containing a bearer. In the forward direction, different bearers are assigned to different frames which are multiplexed together in the same frequency channel (TDM). In the return direction, different terminals may transmit bearers in different time slots which may be in the same frequency channel (TDMA). The frame period is 80 ms and the time slot period may be 80, 20 or 5 ms.

The supported bearer parameters are as follows:

TABLE 3
Bearer Parameters

| Modulation | Symbol Rate (kS/s) |
|---|---|
| 4-ary (π/4 QPSK), 16 QAM | 16.8, 33.6, 67.2, 151.2 |

However, not all possible combinations are supported, because some are redundant and others do not provide suitable performance for any type of communication in any beam with any terminal.

The supported bearer types are identified herein by a code of format DPTRM indicating direction D, burst period P, type T (which is used merely as a separator), symbol rate R, and modulation M as follows:

TABLE 4
Bearer Parameter Codes

| D | P (ms) | R (33.6 kS/s) | M |
|---|---|---|---|
| F = Forward | 80 | 0.25 | X = 16-QAM |
| R = Return | 20 | 0.5 | Q = π/4 QPSK |
| | 5 | 1 | |
| | | 2 | |
| | | 4 | |
| | | 4.5 | |
| | | 5 | |

For example, the code F80T4.5X means a forward bearer with 80 ms burst length, symbol rate 151.2 kS/s, 16-QAM modulation. Optional code suffixes 2B or 4B may be added to indicate the number of FEC blocks which the bearer burst contains. Each FEC block is FEC encoded independently.

The supported bearers, together with their associated bandwidth, are shown below in Table 5:

TABLE 5
Supported Bearers

| Code | Bandwidth (kHz) |
|---|---|
| R20T0.5Q | 21 |
| F80T1Q4B | 42 |
| F80T1X4B | 42 |
| R20T1Q | 42 |
| R20T1X | 42 |
| R20T2X | 84 |
| R5T2X | 84 |
| R20T2Q | 84 |
| R5T2Q | 84 |
| F80T4.5X | 189 |
| R20T4.5Q | 189 |
| R5T4.5Q | 189 |
| R20T4.5X | 189 |
| R5T4.5X | 189 |

However, R5T4.5Q and R5T4.5X are optional as their data rate is equivalent to that of the R20T1 bearers but they are less bandwidth efficient. Furthermore, some other possible bearers may be implemented for backwards compatibility with existing systems, such as F80T1X2B and F80T1Q2B.

Shared Frequency Channels

Each frequency channel transmitted by the satellite may be shared in frequency between different bearers each occupying less than one half of the available bandwidth. For example, a 190 kHz frequency channel may contain two 84 kHz bearers, four 42 kHz bearers, eight 21 kHz bearers, or a combination of these. Likewise, a 90 kHz frequency channel may contain two 42 kHz bearers, four 21 kHz bearers or a combination of these such as one 42 kHz bearer and two 21 kHz bearers. Forward bearers which are adjacent in frequency and have the same modulation scheme are transmitted synchronously, allowing simultaneous demodulation of multiple bearers by the MANs. The MANs are able to receive up to four adjacent bearers in this way. This adds flexibility in the data rate and/or channel type provided to an MAN. For example, two 42 kHz bearers may be assigned to an MAN where a single 84 kHz or 189 kHz bearer is not available, such as in a regional beam RB. One bearer may be used for unicast data stream or signalling and the second could be a broadcast/multicast bearer. Hence, bearer acquisition need only be performed once for multiple synchronous bearers. Moreover, symbol timing may be synchronised between successive frames to assists the MANs in acquiring timing. Even where the coding rate of a block is too high for an MAN to decode successfully, the MAN may still detect the symbol timing and will therefore be able to decode subsequent blocks with lower coding rates.

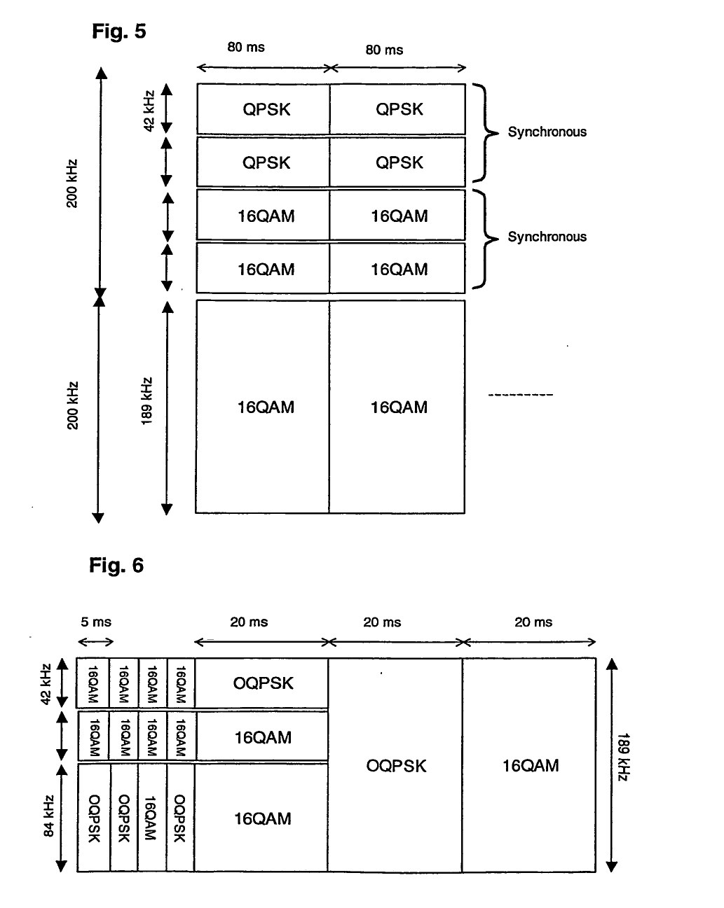

An example of shared forward frequency channels is shown in FIG. 5, in which a first 200 kHz channel contains two F80T1X and two F80T1Q bearers, while a second 200 kHz channel contains one F80T4.5X bearer. FIG. 5 shows the same shared frequency channel format between two adjacent frames, but adjacent frames may contain different shared channel formats. For example, the modulation scheme may be varied on each frequency subchannel between frames, and an MAN receiving that subchannel may automatically detect any changes in modulation between frames. Automatic detection is facilitated by selecting from modulation schemes which are sub- or supersets of one another (e.g. QPSK and 16QAM).

An example of shared return frequency channels is shown in FIG. 6, in which one frame of a 200 kHz channel contains the following bearer types multiplexed in frequency and time: R5T1X (×8), R5T2Q, R5T2X (×3), R20T1Q, R20T1X, R20T2X, R20T4.5Q, R20T4.5X.

The sharing schedule of each return frequency channel is controlled by the SAN and transmitted in Return Schedule packets in the forward bearers. The return schedule dictates the bearer types and their arrangement within a frame.

Coding Rate Subtypes

Each bearer type comprises a set of subtypes having different FEC coding rates to provide different carrier to noise ratios C/No. The subtypes are identified by codes as shown below in Tables 6 and 7 for 4-ary and QAM bearers respectively. The exact coding rate values are optimised for each bearer type in such a way that the data payload carries an integer number of octets.

TABLE 6
Subtypes for 4-ary bearers

| Subtype | L8 | L7 | L6 | L5 | L4 | L3 | L2 | L1 | RE | H1 |
|---|---|---|---|---|---|---|---|---|---|---|
| Code Rate | 1/3 | 2/5 | 1/2 | 5/9 | 5/8 | 2/3 | 3/4 | 4/5 | 5/6 | 7/8 |

TABLE 7
Subtypes for QAM bearers

| Subtype | L3 | L2 | L1 | RE | H1 | H2 | H3 | H4 | H5 | H6 |
|---|---|---|---|---|---|---|---|---|---|---|
| Code Rate | 1/3 | 2/5 | 4/9 | 1/2 | 4/7 | 5/8 | 2/3 | 3/4 | 4/5 | 6/7 |

For each bearer type, a range of discrete coding rates is selected to give progressive changes of approximately 1 dB in the C/No performance of the bearer, as described below.

Forward Frame Format

The forward bearer formats include an initial UW and distributed pilot symbols. The frame duration is 80 ms.

Bearer types F80T1Q4B and F80T1X4B are low bandwidth high-penetration bearers used for communicating with small aperture terminals, and for signalling. Each frame is divided into four 20 ms FEC blocks.

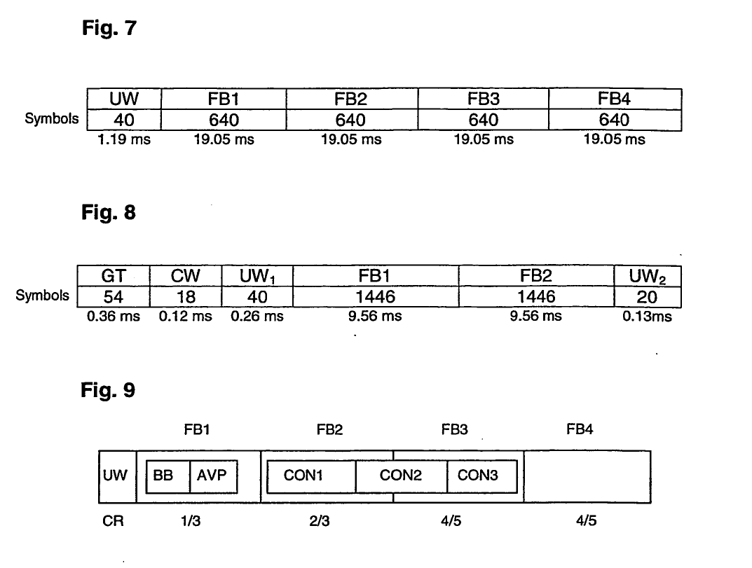

An example of the F80T1Q4B format is shown in FIG. 7. In this example, an initial UW of 40 symbols (1.19 ms duration) is followed by four FEC blocks FB₁ to FB₄ each of 640 symbols (19.05 ms duration), including one pilot symbol after every 29 FEC symbols, giving a total of 29 pilot symbols per frame.

The possible coding rate subtypes for the F80T1Q4B bearer, together with the associated data rate, C/No requirement for burst error rate of 10⁻³, step in C/No requirement, and Eb/No is shown below in Table 8:

TABLE 8
F80T1Q4B Coding Rate Subtype Performance

| Coding | | C/No | | |
|---|---|---|---|---|
| Rate | Data Rate | Required | C/No Step | |
| Subtype | (kBit/s) | (dBHz) | (dBHz) | Eb/No (dB) |
| L8 | 21.6 | 44.98 | — | 1.43 |
| L7 | 25.6 | 45.84 | 0.86 | 1.55 |
| L6 | 30.4 | 46.82 | 0.98 | 1.78 |
| L5 | 35.2 | 47.71 | 0.89 | 2.04 |
| L4 | 40.0 | 48.60 | 0.89 | 2.37 |
| L3 | 44.8 | 49.53 | 0.93 | 2.81 |
| L2 | 49.2 | 50.46 | 0.93 | 3.33 |
| L1 | 52.8 | 51.52 | 1.06 | 4.09 |
| RE | 55.6 | 52.49 | 0.97 | 4.83 |

Bearer type F80T4.5X is a high bandwidth low penetration bearer used for traffic data. Each frame is subdivided into eight 10 ms blocks to reduce latency, so that this bearer is suitable for voice and video-conferencing applications.

Return Burst Formats

The duration of return bursts may be either 5 ms or 20 ms, the 5 ms burst length being chosen for low-latency applications. There is only one FEC block per burst except for the highest symbol rate (R=4.5, 151.2 kS/s) where there are two FEC blocks to avoid an excessive memory requirement for the FEC encoders. On the other hand, a block size of less than about 20 octets is not viable because the turbo decoder performance starts to degrade when the data payload is lower than this threshold. This places a lower limit on the other parameters for a 5 ms slot: a minimum symbol rate of 33.6 kS/s with 16-QAM modulation or 67.2 kS/s. with 4-ary modulation.

An example of the R20T4.5X bearer structure is shown in FIG. 8 and comprises a guard time interval GT of 54 symbol periods in which no symbols are transmitted, a preamble CW of 18 symbols, initial unique word UW1, two FEC blocks FB1 and FB2, and final unique word UW2. The coding rate subtypes and associated performance metrics are shown below in Table 9:

TABLE 9
R20T4.5X Coding Rate Subtype Performance

| Coding Rate | Data Rate | C/No Required | C/No Step |
|---|---|---|---|
| Subtype | (kBit/s) | (dBHz) | (dBHz) |
| L3 | 192.8 | 55.73 | — |
| L2 | 225.6 | 56.71 | 0.98 |
| L1 | 258.4 | 57.66 | 0.95 |
| R | 292.0 | 58.58 | 0.92 |
| H1 | 332.0 | 59.64 | 1.06 |
| H2 | 372.0 | 60.69 | 1.05 |
| H3 | 408.0 | 61.66 | 0.97 |
| H4 | 448.0 | 62.76 | 1.10 |
| H5 | 475.2 | 63.75 | 0.99 |
| H6 | 492.8 | 64.68 | 0.93 |

Adaptive Coding Rate

For all bearer types, the coding rate is variable and can be set independently for each FEC block. The coding rate may be varied in response to the measured C/No for that bearer to achieve a burst error rate performance of 10⁻³. The SAN measures the C/No for each return bearer, determines whether any change to the coding rate is required, and if so signals the required change to the MAN transmitting that bearer. The SAN makes a corresponding change in the coding rate to any forward bearers transmitted to that MAN.

In one example, the SAN measures the C/No of each received burst. Based on the received burst type and subtype, and the type of the transmitting MAN, the SAN calculates a gain correction value that is transmitted in a signalling packet to the MAN which transmitted the burst. The MAN may change its transmit power and/or its coding rate to achieve the gain correction indicated by the correction value.

The MAN may also measure the C/No for a received forward bearer and, if the C/No value falls outside a predetermined range and subsequently no instructions to change the coding rate are received from the SAN within a timeout period, the MAN may change the coding rate of its transmitted return bearers so as to compensate for the channel conditions on the return link, on the assumption that the channel conditions are symmetrical on the forward and return links.

Alternatively, the coding rate of the transmitted return bearers may be determined entirely by the MAN based on received on the measured C/No of the forward bearer, and is not signalled by the SAN.

In forward bearers, the coding rate for the first FEC block in a burst is signalled by the initial UW in that burst; the UW is selected by the TCU from a set of UWs, each corresponding to the different coding rate subtypes. Any coding rate changes for subsequent FEC blocks in the burst are signalled by a broadcast signalling packet contained in the first FEC block; if there is no change, this packet is omitted.

As an example, the correspondence between UWs and coding levels for F80X/Q bearers is shown in Table 10 below:

TABLE 10
UWs Corresponding to Coding Rates for F80X/Q Bearers

| Coding rate | Unique Word Symbols | | | | | | | | | |
|---|---|---|---|---|---|---|---|---|---|---|
| L8 | E | 4 | 5 | 6 | 4 | A | D | A | D | B |
| L7 | B | E | D | 8 | B | 3 | E | A | D | 2 |
| L6 | F | 2 | F | 5 | F | 4 | 9 | 6 | A | 6 |
| L5 | C | 9 | 1 | 1 | 3 | 6 | 4 | 2 | 8 | A |
| L4 | F | 9 | A | 4 | 2 | B | B | 1 | A | B |
| L3 | D | 4 | E | 3 | 5 | 7 | 2 | 9 | 9 | C |
| L2 | 4 | C | B | 9 | D | 9 | D | 1 | 7 | 4 |
| L1 | 6 | A | A | F | 7 | A | 6 | E | 4 | E |
| R | C | 2 | 4 | 0 | E | 9 | 6 | 5 | 8 | 7 |
| H1 | 5 | 1 | 4 | B | B | 8 | B | A | 6 | 2 |
| H2 | B | 5 | 8 | 9 | 6 | C | C | D | D | F |
| H3 | A | 8 | 7 | B | 0 | D | A | 6 | C | 9 |
| H4 | 5 | A | 1 | A | 6 | 7 | 9 | D | 6 | F |
| H5 | 6 | 1 | F | E | A | 5 | 4 | 9 | 4 | 3 |
| H6 | A | 3 | 2 | A | D | 2 | 8 | 1 | C | 4 |
| H7 | 7 | 7 | 5 | D | 1 | B | 0 | 5 | 5 | 8 |
| H8 | D | F | B | 2 | 8 | 8 | 0 | E | 9 | 1 |

In return bearers, the coding rate is also indicated in the initial UW selected by the MAN. The symbol rate may also be adjusted on a burst-by-burst basis and is determined by the return schedules as described above.

Power Save Mode

If there is no data to send in any block of a frame of a 16-QAM bearer, a predefined transmit sequence is transmitted in which dummy data symbols occupy only the inner points of the 16-QAM constellation, while the pilot symbols occupy their normal outer constellation points. This saves approximately 6 db in transmit power.

Shared Forward Bearers

To optimise the use of satellite bandwidth, a single forward bearer may contain data addressed to multiple MANs of differing gain. This either restricts the maximum data rate achievable on the bearer, or precludes service to smaller aperture terminals. Furthermore, where the available bandwidth is limited in a beam, or where the receiving MANs are unable to process high bandwidth signals, narrow band (42 kHz) bearers will be used. The mean power of a forward bearer is fixed for the duration of the frame and is set to provide a link of at least threshold performance with the least capable receiving MAN.

In the example shown in FIG. 9, a bearer contains a UW which indicates an initial coding rate CR of ⅓ and four FEC blocks FB1 to FB4. The first block FB1 contains a bulletin board packet containing a bulletin board header BB and a coding rate attribute value pair AVP which indicates that the coding rates for the blocks FB2 to FB4 are ⅔, ⅘ and ⅘ respectively. The initial coding rate of ⅓ is chosen so that the least capable of the MANs receiving this bearer will be able to receive the bulletin board packet. Hence, the initial coding rate will be less than or equal to any of the subsequent coding rates. A MAN which determines that it will be unable to decode blocks of higher coding rate may save power by not demodulating those blocks. Blocks FB2 and FB3 contain packets CON1, CON2 and CON3 corresponding to connections to different MANs. The packet CON2 is split over the block boundary and therefore the MAN receiving this packet must be able to decode successfully at a coding rate of ⅘.

Where possible, packets addressed to MANs of the same type are assigned to the same bearer, so that the transmission performance is not limited for more capable MANs by the presence of packets addressed to less capable MANs on the same bearer. However, in low traffic conditions, packets addressed to different types of MAN may be assigned to the same bearer so as to conserve bandwidth. As the traffic level increases, selected MANs may be migrated onto other bearers so as to group them together with other MANs of the same type.

Alternative Applications

Embodiments of the present invention may be applied to many different types of wireless communication system, including without limitation geostationary, geosynchronous and non-geosynchronous satellite communication systems and terrestrial wireless communication systems. In the case of satellite systems, the satellites may be processing or switching satellites instead of “bent-pipe” or repeater satellites.

1. A method of transmitting a plurality of forward error corrected blocks within a burst, wherein the forward error-correction coding rate varies among the forward error corrected blocks, the burst includes a header indicating the coding rate of one of the blocks and said one of the blocks contains data indicating the coding rate of a subsequent one or more of the blocks.

2. A method according to claim 1, wherein said one of the blocks is a first one of the blocks to be transmitted.

3. A method according to claim 1 or claim 2, wherein said header comprises a variable unique word.

4. A method according to any preceding claim, wherein the blocks contain packets addressed to a plurality of receivers.

5. A method according to claim 4, wherein at least some of the packets are split between different ones of the blocks.

6. A method according to any preceding claim, wherein the coding rate indicated in the header is less than or equal to the coding rate of the subsequent one or more blocks.

7. A method of transmitting a data burst comprising a unique word and a plurality of blocks, wherein the unique word is variable and indicates the transmission scheme of at least one of said blocks, and said at least one block indicates the transmission scheme of at least one other of said blocks.

8. A method of wireless transmission from a transmitter to a plurality of receivers, wherein the transmission includes a plurality of packets addressed respectively to the receivers, the method including determining the least capable of the receivers and selecting one or more parameters of the transmission so as to match the capabilities of the least capable of the receivers.

9. A method according to claim 8, wherein the transmission includes a forward error-corrected block having a coding rate selected to match the capabilities of the least capable of the receivers.

10. A method of wireless transmission from a transmitter to a plurality of receivers, the method comprising transmitting a burst containing a plurality of forward error-corrected blocks, at least one of which includes part or all of a plurality of packets addressed to different ones of said plurality of receivers and has a coding rate selected so as to match the capabilities of the least capable of the receivers to which the packets are addressed.

11. A method according to claim 10, wherein at least some of the packets are split between different forward error-corrected blocks.

12. A method of assigning a plurality of packets addressed to a respective plurality of wireless receivers to a plurality of bearers, the method comprising identifying the receiving capabilities of the wireless receivers and assigning packets addressed to ones of the receivers having similar receiving capabilities onto the same one of said bearers.

13. A method of assigning a plurality of receivers to a plurality of bearers for reception of packets addressed to the receivers, the method comprising: in a first, low traffic condition, assigning packets to a smaller number of bearers containing packets addressed to receivers of differing receiving capabilities, and in a second, high traffic condition, assigning packets to a greater number of bearers and assigning packets addressed to those of the receivers having similar receiving capabilities onto the same one of said greater number of bearers.

14. A method of transmission over a satellite link between a satellite station and a mobile satellite terminal able to transmit at a selected one of a plurality of different forward error correction (FEC) coding rates wherein a change between successive ones of said FEC coding rates provides a substantially constant change in gain over the satellite link, the method comprising, at the terminal: transmitting a plurality of bursts to the satellite station, wherein the FEC coding rates of the bursts vary between at least some of said bursts in response to a signal from the satellite station.

15. A method according to claim 14, wherein said signal is dependent on a reception quality of one or more of said bursts previously received from the mobile satellite terminal by the satellite station.

16. A method according to claim 14 or claim 15, wherein the mobile satellite terminal selects the FEC coding rates of at least one of said bursts dependent on a reception quality of one or more transmissions transmitted from the satellite station to the mobile satellite terminal if said signal is not received from the satellite station within a timeout period.

17. A method of controlling a transmission to a satellite station from a mobile satellite terminal, able to transmit at a selected one of a plurality of different forward error correction (FEC) coding rates wherein a change between successive ones of said FEC coding rates provides a substantially constant change in gain over the satellite link, the method comprising, at the satellite station: receiving a first burst from the mobile satellite terminal and determining a reception quality of the first burst, and if the reception quality does not meet a predetermined criterion, transmitting a command to the mobile satellite terminal to select a different one of the FEC rates for transmission of a second, subsequent burst such that the second transmission is received with a reception quality which meets the predetermined criterion.

18. A method according to any of claims 14 to 17, wherein said substantially constant change in gain is approximately 1 dB.

19. A method according to any of claims 14 to 18, wherein the satellite station is a satellite ground station for communicating with the satellite terminal via a satellite.

20. A method according to any one of claims 14 to 18, wherein said satellite station is a satellite.

21. A signal generated by a method according to any one of claims 1 to 20.

22. Apparatus arranged to perform the method of any one of claims 1 to 20.
